(19) United States
(12) Patent Application Publication
(10) Pub. No.: US 2003/0084889 A1
(43) Pub. Date: May 8, 2003

(54) Make voltage ignition coil and method of making

(76) Inventors: Albert Anthony Skinner, Anderson, IN (US); Raymond O. Butler JR., Anderson, IN (US)

Correspondence Address: MARGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 10/008,481

(22) Filed: Nov. 5, 2001

(51) Int. Cl. F02P 9/00

(52) U.S. Cl. 123/609; 123/643; 123/634; 123/651

(57) ABSTRACT

An AC ignition system for an internal combustion engine having a voltage source, an ignition coil coupled to the voltage source and at least one spark plug having a spark gap, the ignition coil has a primary winding and a secondary winding, the secondary winding has a high turn ratio with respect to the primary winding. The primary winding is electrically coupled to the voltage source and the secondary winding is electrically connected to the spark gap. A switch is connected in series with the primary winding and is configured for movement between an open position and a closed position the closed position electrically couples the voltage source to the primary winding. The ignition coil generates a make voltage after the primary winding is coupled to the voltage source. The make voltage is sufficient to ionize the spark gap. A controller generates a control signal for alternately opening and closing the switch for a desired spark duration, the ignition coil operates in an inductive coupling mode upon opening of the switch and in a transformer coupling mode upon closure of the switch after the primary is initially coupled to the voltage source, the secondary winding generates an AC spark during the desired spark duration.

### TECHNICAL FIELD

The present application relates to an ignition coil and method of manufacturing, more particularly, a method and apparatus for providing an ionization voltage.

### BACKGROUND

A typical automotive ignition system includes a spark plug for each combustion chamber of an engine, at least one ignition coil and at least one device adapted to selectively charge the coil(s) and cause the energy stored in the coil(s) to be discharged through the spark plugs in a timed manner. As a result, a spark is generated and ignition of a fuel-air mixture in each combustion chamber occurs at a specified timing.

When charging of the coil is initiated, however, a transient voltage is created. This kind of sparking event is commonly referred to as a spark-on-make event or condition because historically it would occur when the breaker points of the ignition system made contact to commence charging of the ignition coil. The term “spark-on-make”, as used in this disclosure however, is not limited to situations where conventional breaker points are used. To the contrary, it refers to any situation where initiation of coil or ignition system charging causes a spark at one or more of the spark plugs. Traditionally, this kind of sparking event was considered undesirable because it was not timed for proper engine operation.

Recent advances in technology have made it more practical and desirable in some situations to provide a coil-per-cylinder ignition arrangement (e.g., wherein a coil is provided for each cylinder of the engine).

Each spark plug therefore has its own ignition coil. A direct connection to the spark plug is preferred because it eliminates the need for high voltage wires from a distributor to each of the spark plugs. Instead, all of the wiring to the spark plugs from the power train control unit (PTCU) of the engine can be provided using inexpensive and compact low-voltage wiring.

### SUMMARY

An ignition coil is provided for an internal combustion engine. The ignition coil comprises a primary winding and a secondary winding. The primary winding is adapted to be electrically connected to a low-voltage ignition signal. The secondary winding is inductively coupled to the primary winding with many more turns than the primary winding so that spark plug ionization voltages can be met with the initial “make” voltage.

An AC ignition system for an internal combustion engine having a voltage source, an ignition coil coupled to the voltage source and at least one spark plug having a spark gap, the ignition coil has a primary winding and a secondary winding, the secondary winding has a turn ratio of 800:1 with respect to the primary winding. The primary winding is electrically coupled to the voltage source and the secondary winding is electrically connected to the spark gap. A switch is connected in series with the primary winding and is configured for movement between an open position and a closed position the closed position electrically couples the voltage source to the primary winding. The ignition coil generates a make voltage after the primary winding is coupled to the voltage source. The make voltage is sufficient to ionize the spark gap. A controller generates a control signal for alternately opening and closing the switch for a desired spark duration, the ignition coil operates in an inductive coupling mode upon opening of the switch and in a transformer coupling mode upon closure of the switch after the primary is initially coupled to the voltage source, the secondary winding generates an AC spark during the desired spark duration.

Still other objects, advantages, and features of the present invention will become more readily apparent when reference is made to the accompanying drawings and the associated description contained herein.

### BRIEF DESCRIPTION OF THE DRAWINGS

FIG. 1 is cross-sectional view of an ignition coil;

FIG. 2 is a schematic illustration of a circuit for use with an ignition coil constructed in accordance with an exemplary embodiment of the present invention;

FIG. 3 is a block diagram of an ignition system using an ignition coil and driver constructed in accordance with an exemplary embodiment of the present invention; and

FIG. 4 illustrates waveforms generated by the operation of the driver illustrated in FIG. 2.

### DESCRIPTION OF THE PREFERRED EMBODIMENT

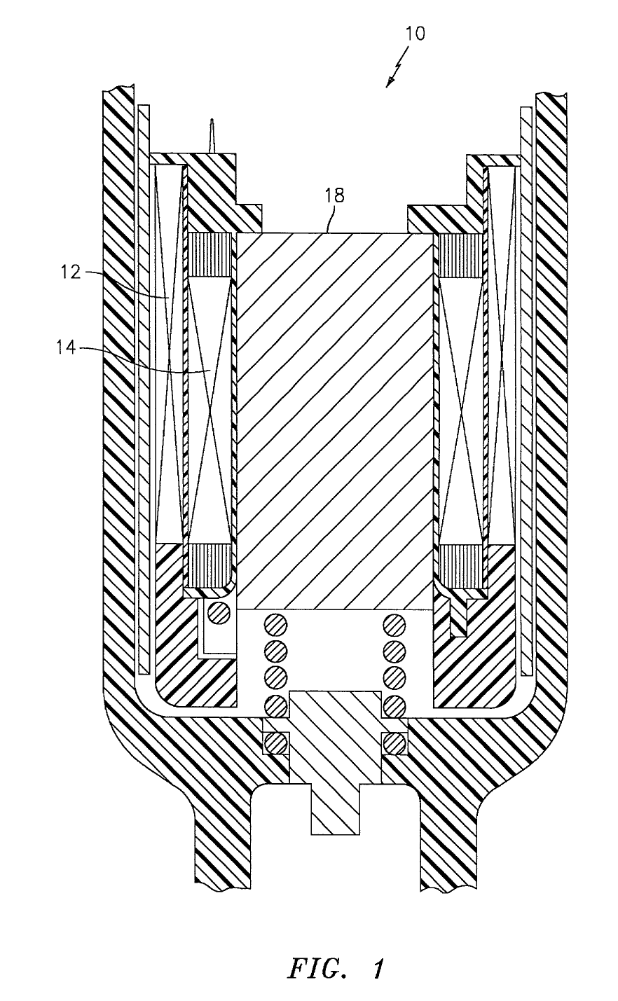

With reference to FIG. 1, an ignition coil 10 includes a primary winding 12 and a secondary winding 14. Both of the windings 12 and 14 circumferentially surround the same magnetic core 18.

In accordance with an exemplary embodiment secondary winding 14 is wind about the magnetic core. Magnetic core 18 preferably is made of iron.

The ignition coil 10 can be installed in an automotive vehicle or otherwise to provide sparks in one or more combustion chambers of an internal combustion engine via spark plugs located therein. The automotive implementation of the present invention represents a preferred use upon which the following description will be based. The invention, however, is not limited to such use. To the contrary, the present invention can be used in connection with other implementations of an internal combustion engine as well as other non-internal combustion engine applications.

The primary winding 12 is adapted to be electrically connected to a low-voltage ignition signal. Terminals (not shown), for example, can be electrically connected to respective ends of the primary winding 12. These terminals then can be connected to the low-voltage ignition signal through soldering or any other suitable connection technique.

The secondary winding 14 is inductively coupled to the primary winding 12 with many more turns than the primary winding 12 so that any voltage induced across the secondary winding 14 in response to switching of the low-voltage ignition signal causes the secondary winding 14 to develop a high-voltage ignition signal.

In accordance with an exemplary embodiment, the ratio of turns of the secondary coil to the primary coil is 800:1. Of course, other ratios are contemplated in accordance with the present invention. For example, a range of 700:1 through 900:1 is contemplated for providing the make voltages necessary to break down the gap. Of course, other combinations are within the spirit of the present application. However, a high turns ratio is necessary for implementing the present invention.

In accordance with an exemplary embodiment a 42-volt system and a very high turns ratio coil (800:1) provides spark plug ionization voltages with the initial “make” voltage of the coil. As referred to herein “make” voltage defines the voltage induced across the secondary coil when the primary coil is initially energized.

The high turns ratio coil enables the ionization voltages to be met with the “make” voltage. In a typical coil (e.g. 35:1 turns ratio) the make voltage is 2 or 3 kv.

However, a coil with an 800:1 turns ratio has been shown to provide 35 kv on make voltage. Gap break down can be accomplished with a make voltage typically in a range of 8 kv and the upper or high 20's with 15 kv being the most typical value. These values are for purposes of explanation and are not intended to be limiting. Accordingly, and in accordance with an exemplary embodiment when the EST first goes high the spark plug gap is broken down with the necessary voltage.

Accordingly, the gap is broken down with the make voltage and then with high turns ratio the coil can supply the voltage to keep the gap burning.

In addition, and since the secondary has many more turns of wire the driver for this coil will not encounter voltages higher than system voltages. For example, and in accordance with an exemplary embodiment when the coil is turned on (e.g. switch closed) approximately 42 volts are seen by the driver of this system, when the coil is turned off (e.g. switch open) the range of voltages seen are approximately ½ volt to 4 volts.

A typical ignition driver sees between 360 and 660 volts, which require fairly high cost high insulated gate bi-polar transistor (IGBT) or darlingtons to be used.

In accordance with an exemplary embodiment, the lower voltages allow field effect transistors (FETs) to be used. In comparison to IGBTs field effect transistors are provided at a lower cost.

In operation, the system would turn on the primary and apply a system voltage across the primary. In approximately 10 to 20 μsec the spark plug gap will break down. The breakdown time depends on the ionization requirement which is a function of the plug and the combustion chamber.

The primary will remain on until a preset current is reached. At this current checkpoint the primary would be shut off.

Energy left in the coil would then continue the current flow through the gap in the opposite direction as the flux in the coil collapses. When the secondary current hits its preset threshold the primary would then turned back on, continuing to cycle.

If the cycle were interrupted for any reason, such as high levels of turbulence in the gap, when the primary was turned back on there would be sufficient voltage to re-ionize the gap and continue cycling.

Accordingly, coil 10 provides a simple low-cost alternative for a continuous delivery of energy. In addition, no dwell calculations are needed as in a standard inductive system since the coil fires as it is turned on rather than as it is turned off. Thus, the variable burn time spark is easily controlled by the engine control module ECM. Moreover, what was the EST (dwell) signal from the ECM now becomes the spark signal.

Systems requiring a high-voltage source yield a higher cost. Systems that can only sustain the burn voltage have the disadvantage of not being able to re-establish the arc if it is “blown out”. In addition, these systems also require a standard dwell table.

Another problem with theses systems is that a diode is necessary to block “make voltage” from ionizing the gap. In these systems the “make voltage” is undesirable since these systems are turned on ahead of the correct spark timing. Without a diode the turns ratio can only be taken so high (approximately 35:1 max with a 42 volt system). This limits the bum voltage that can be supported and would have difficulty at high loads and/or low battery voltages.

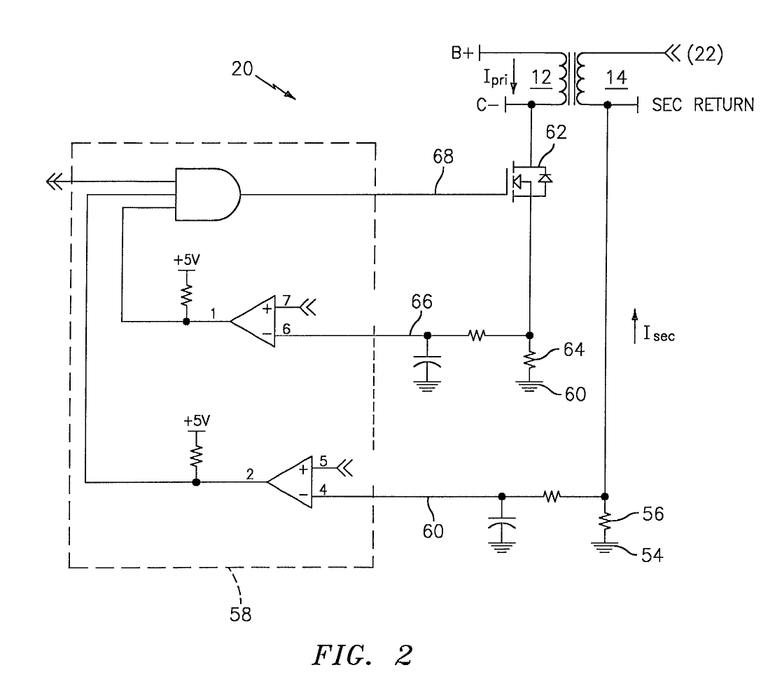

Referring now to FIG. 2, a schematic illustration for a circuit 20 for driving the coil is illustrated. As discussed above once the system voltage is applied to the primary the secondary will break down the gap of a spark plug 22.

The primary will rise to a given primary current switch off value and the secondary will conduct until a threshold value and then the primary is cycled back on.

Accordingly, the only timing requirement is to set the width of the EST, as there is no need for dwell calculations since the spark plug ionization voltage is met with the initial “make” voltage.

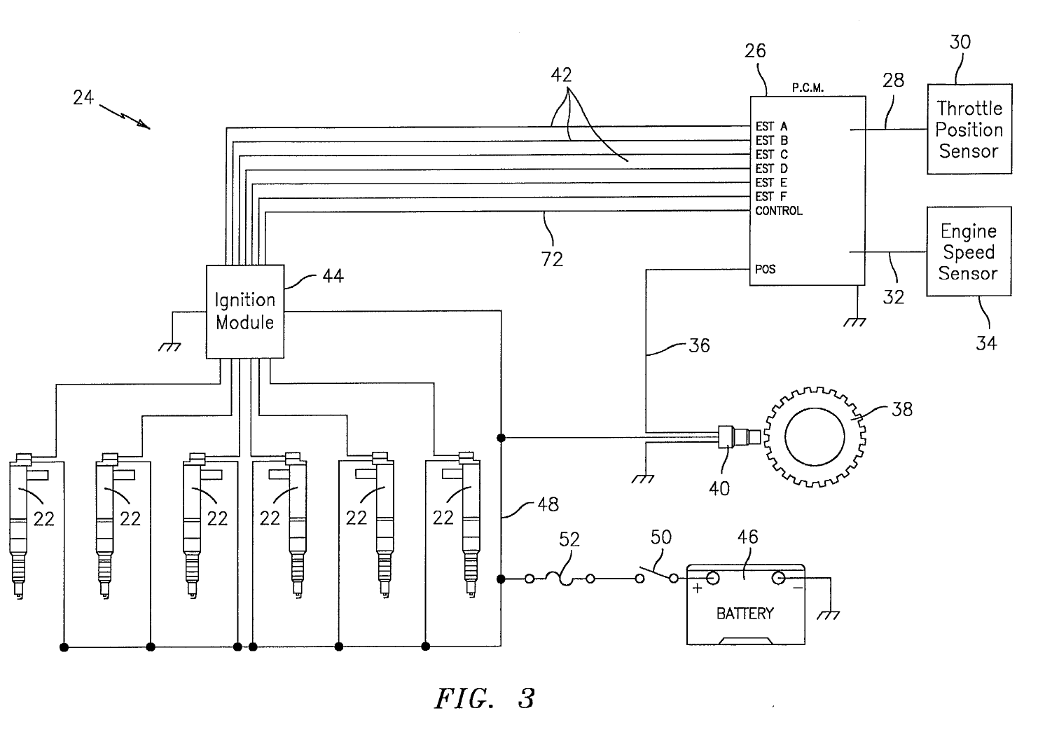

Referring now to FIGS. 2 and 3, an exemplary distributorless AC ignition system, generally designated 24, for an internal combustion engine with sequential fuel injection is illustrated. The AC ignition system used in the present example, as shown, is for an engine having six cylinders, however, the invention may be practiced with an engine having any number of cylinders.

The AC ignition system 24 includes a Powertrain Control Module (PCM) 26 that receives various sensor inputs including a throttle position sensor signal on line 28 such as from a conventional potentiometer 30, an engine speed signal on line 32 such as from a cooperative toothed wheel and variable reluctance sensor 34, and an engine crankshaft position signal on line 36 such as from a toothed encoder wheel 38 and variable reluctance sensor 40. These input quantities and others provide data to the PCM 26 for controlling engine and transmission functions including developing appropriate electronic spark tuning (EST) signals.

PCM 26 communicates EST signals, generally digital pulses, by way of lines 42, to ignition module 44 for controlling the timing and duration of the firing of the spark plugs 22. While being illustrated as generating separate EST signal on separate lines 42, it is possible to provide a single EST pulse line containing appropriate EST timing signal for distribution by additional hardware (not shown) within the ignition module 44. Ignition module 44 includes a plurality of ignition controllers 20 (FIG. 2) that provide current to each respective spark plug 22 through coils 10 in accordance with corresponding EST timing signal.

A direct voltage source 46, which is shown as a battery, provides power to the electronic components and circuits through line 48. An ignition switch 50 and fuse 52 are connected in series with the battery to control the application of voltage to the electronic components. Battery voltage is provided to the ignition system upon closure of the ignition switch 50. Typically, the voltage of the battery ranges between 12-15 volts dc for 12-volt system and 36-45 volts for a 42 volts system.

An exemplary embodiment of an ignition controller 20 of the present invention is shown in FIG. 2. Each ignition controller 20 for igniting or firing of each spark plug is substantially the same and therefore, one ignition controller is described with the understanding that the other ignition controllers are the same. The ignition controller 20 switches primary current through the primary winding 12. The secondary winding 14 of coil 10 initiates a spark firing voltage VSEC to the spark plug 22 that is associated with a cylinder of a spark ignited internal combustion engine. One end of the secondary winding 14 is connected to one electrode of the spark plug 22 and the other end of the secondary winding 14 is connected to ground 54 through secondary current sensing resistor 56. The turns ratio N between the primary and secondary windings 12 and 14 may be about 1:800, that is there are about 800 turns on the secondary winding for every turn on the primary winding. The voltage drop across sensing resistor 56 is representative of the secondary current ISEC passing through the secondary winding 14 of the ignition coil 10. This voltage across resistor 56 is provided to a current controller 58 via line 60.

One end of the primary winding 14 is connected to the battery 46 and the other end is connected to ground 60 through a field effect transistor (FET) 62, and a primary current sensing resistor 64 connected in series. The FET has a collector c, base b and emitter e. The collector c of the FET 62 is connected to the other end of the primary winding 12 and the emitter e is connected to ground 60 through resistor 64. The voltage drop across sensing resistor 64 is representative of the primary current I_{PRI} passing through the primary winding 12 of the ignition coil 10. This voltage across resistor 64 is provided to current controller 58 via line 66.

Current controller 58 includes drive electronics that provide an oscillating signal to the base b of FET 62 via line 68 in response to the EST signal and the primary current I_{PRI} and secondary current I_{SEC} of the ignition coil 10 at lines 66 and 60 respectively.

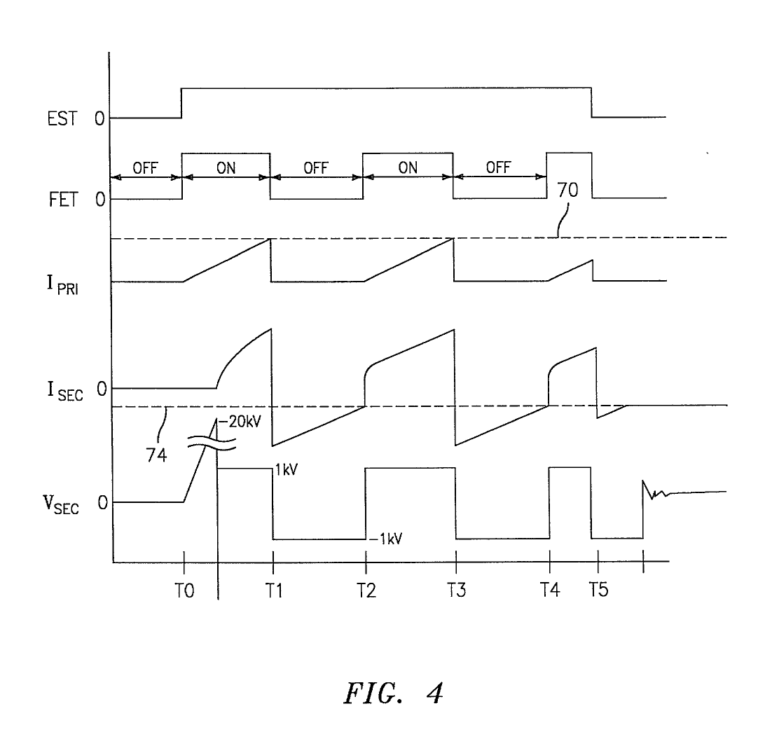

The operation of the present invention shown in FIGS. 1-3 will now be described with the aid of the waveforms shown in FIG. 4. The waveforms shown in FIG. 4 are plotted against elapsed time and some of the waveforms use symbols that are shown in FIG. 2. These waveforms are not to scale and are not intended to illustrate actual voltage or current values.

Prior to T0, the EST signal is low, and in accordance with the software program, the current controller 58 turns off FET 62 to block current flow through the primary winding of the ignition coil. At time T0, PCM 26 commands the current controller to generate a spark across the spark gap by presenting a high EST signal. The current controller continues to maintain the spark across the spark gap as long as the EST signal is high and therefore, the period of time that the EST signal is high defines the approximate spark duration. In response to the high EST signal, the current controller provides a high signal via line 68 to turn on the FET which in turn conducts current I_{PRI} from the battery through the primary winding of the ignition coil to the ground. The primary current I_{PRI} rises at the rate of (V_{B}/R)×(1−e(−Rt/L)) where V_{B} is the voltage of the battery, L is the inductance of the primary winding, R is the primary resistance, and t is the time. The voltage V_{SEC} of the secondary winding rises extremely fast to a very large value because of the large turns ratio N (e.g. 1:800) of the ignition coil. Thus, very shortly after time T0, an arc across the spark gap is initially established through the make voltage.

The primary current I_{PRI} continues to rise until it equals a reference current level value or set point 70 (at time T1). The reference current value 70 may be provided by the PCM 26 via control line 72 or by a predefined value stored in the current controller. In response to the primary current I_{PRI} equaling the reference current value 70, the current controller provides a low signal via line 68 to turn off the FET 62 (at time T1).

At time T1, the primary current IPRI is turned off and the magnetic field quickly collapses generating a high secondary voltage V_{SEC} of opposite polarity. The secondary current falls until it equals a reference current I_{SEC} level value or set point 74 (at time T2). The secondary reference current value 74 may be provided by the PCM 26 via control line 72 or by a predefined value stored in the current controller. In response to the secondary current I_{SEC} equaling the reference current value 74, the current controller provides a high signal via line 68 to turn on FET 62. The primary current I_{PRI} then flows through and builds up in the primary winding and because of the transformer action, the secondary current I_{SEC} reverses its polarity and continues to arc across the spark gap. The polarity of the secondary voltage V_{SEC} also switches.

Between times T2-T3, the primary current I_{PRI} again rises to the reference current level 70, at which time (time T3), the current controller provides a low signal via line 68 to turn off FET 62. At time T3, the arc is maintained as the primary current I_{PRI} is turned off, and the magnetic field quickly collapses generating a high secondary voltage V_{SEC} of opposite polarity. By repeating this process of turning FET 62 on and off, this process continues to produce an alternating spark current which permits the spark to be maintained for any desired length of time. To terminate the arc, the primary current I_{PRI} is cut-off by turning off FET 62 as shown at T5.

Accordingly, and through the use of an ignition coil with a very high turns ratio the spark arc is generated at T0 through the use of initial all are “make voltage”. Thus, there is no need for dwell calculations as the coil fires as it is turned on rather than as it is turned off.

In addition, and since the secondary has many more turns of wire the driver for this coil will not encounter high voltages requiring the use of high cost high insulated gate bi-polar transistors (IGBTs). Therefore, and in accordance with an exemplary embodiment, the lower voltages allow field effect transistors (FETs) to be used.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An AC ignition system for an internal combustion engine, comprising:
a voltage source;
a spark gap;
an ignition coil having a primary winding and a secondary winding, said primary winding being electrically coupled to said voltage source and said secondary winding being electrically connected to said spark gap;
a switch connected in series with said primary winding, said switch being configured for movement between an open position and a closed position, said closed position electrically coupling said voltage source to said primary winding; and
a controller generating a control signal for alternately opening and closing said switch for a desired spark duration, said ignition coil operates in an inductive coupling mode upon opening of said switch and in a transformer coupling mode upon closure of said switch, said secondary winding generating an AC spark upon said primary being coupled to said voltage source and during said desired spark duration.

2. The AC ignition system as in claim 1, wherein the closing of said switch is performed in response to a signal for generating a spark.

3. The AC ignition system as in claim 1, wherein the opening of said switch is performed upon the current in said primary winding reaching a threshold value.

4. The AC ignition system as in claim 3, wherein the closing of said switch is performed upon the current in said secondary winding reaching a threshold value.

5. The AC ignition system as in claim 1, further including a current sensing device for providing a primary current signal representative of the current passing through said primary winding of said ignition coil.

6. The AC ignition system as in claim 1, wherein the controller provides a first signal to open said switch when said primary current signal rises to a primary reference current and a second signal to close said switch after a defined time period.

7. The AC ignition system as in claim 1, further including a primary current sensing device for providing a primary current signal representative of the current passing through the primary winding of said ignition coil and a secondary current sensing device for providing a secondary current signal representative of the current passing through the secondary winding of said ignition coil.

8. The AC ignition system as in claim 1, wherein the controller provides a first signal to open said switch when said primary current signal rises to a primary reference current, and a second signal to close said switch when said secondary current signal falls to a secondary reference current.

9. The AC ignition system as in claim 1, wherein the controller generates said control signal in accordance with a computer program.

10. The AC ignition system as in claim 1, wherein said secondary winding has a turn ratio in a range of 700:1-900:1 with respect to said primary winding.

11. The AC ignition system as in claim 10, wherein said switch is a field effect transistor.

12. An AC ignition system for an internal combustion engine, comprising:
a voltage source;
at least one spark plug having a spark gap;
at least one ignition coil for said at least one spark plug, said ignition coil having a primary winding and a secondary winding, said secondary winding having a turn ratio in a range of 700:1-900:1 with respect to said primary winding, said primary winding being electrically coupled to said voltage source and said secondary winding being electrically connected to said spark gap;
a switch connected in series with said primary winding, said switch being configured for movement between an open position and a closed position, said closed position electrically coupling said voltage source to said primary winding, said ignition coil generating a make voltage after said primary winding is coupled to said voltage source, said make voltage being sufficient to ionize said spark gap; and
a controller generating a control signal for alternately opening and closing said switch for a desired spark duration, said ignition coil operates in an inductive coupling mode upon opening of said switch and in a transformer coupling mode upon closure of said switch after said primary is initially coupled to said voltage source, said secondary winding generating an AC spark during said desired spark duration.

13. The AC ignition system as in claim 12, wherein the closing of said switch is performed in response to a signal for generating a spark.

14. The AC ignition system as in claim 12, wherein the opening of said switch is performed upon the current in said primary winding reaching a threshold value.

15. The AC ignition system as in claim 12, wherein the closing of said switch is performed upon the current in said secondary winding reaching a threshold value.

16. The AC ignition system as in claim 15, further including a current sensing device for providing a primary current signal representative of the current passing through said primary winding of said ignition coil.

17. The AC ignition system as in claim 15, further including a primary current sensing device for providing a primary current signal representative of the current passing through the primary winding of said ignition coil and a secondary current sensing device for providing a secondary current signal representative of the current passing through the secondary winding of said ignition coil.

18. The AC ignition system as in claim 12, wherein the controller provides a first signal to open said switch when said primary current signal rises to a primary reference current, and a second signal to close said switch when said secondary current signal falls to a secondary reference current.

19. The AC ignition system as in claim 18, wherein said switch is a field effect transistor.

20. The AC ignition system as in claim 12, wherein said switch is a field effect transistor.

21. A method for providing a spark across a spark gap in an ignition system, comprising:
coupling a primary winding of an ignition coil to a voltage source;
sensing a current value of said primary winding;
decoupling said primary winding from said voltage source when said current value of said primary winding reaches a threshold value;
sensing a current value of a secondary winding connected across a spark gap;
re-coupling said primary winding to said voltage source when said current value of said secondary winding reaches a threshold value; and
alternatively coupling and decoupling said voltage source across said primary winding for a desired spark duration.
